(19) United States
(12) Patent Application Publication
(10) Pub. No.: US 2017/0096000 A1
(43) Pub. Date: Apr. 6, 2017

(54) MULTI-LAYERED LIGNOCELLULOSIC MATERIALS HAVING AN INNERLYING VAPOR BARRIER

(71) Applicant: BASF SE, Ludwigshafen (DE)

(72) Inventors: JENS AßMANN, Neustadt (DE); Claus FUEGER, Lemberg (DE)

(21) Appl. No.: 15/311,651

(22) PCT Filed: Mar. 25, 2015
(86) PCT No.: PCT/EP2015/056395

§ 371 Date: Nov. 16, 2016

(30) Foreign Application Priority Data
May 19, 2014 (EP) 14168775.6

(51) Int. Cl. B32B 37/14; B32B 5/30; B32B 37/06; B32B 27/32; B32B 37/10; B32B 21/08; B32B 23/08

(52) U.S. Cl. CPC B32B 37/14; B32B 21/08; B32B 5/30; B32B 23/08; B32B 27/32; B32B 37/10; B32B 37/06; B32B 2307/7246; B32B 2471/00; B32B 2479/00

(57) ABSTRACT

The present invention relates to a multilayered lignocellulosic engineering material wherein at least one layer is a vapor barrier layer and at least one vapor barrier layer is below the surface of the lignocellulosic engineering material, and the lignocellulosic layers comprise
A) 30 to 98 wt % of one or more lignocellulosic substances,
B) 0 to 25 wt % of expanded plastics particles having a bulk density in the range from 10 to 150 kg/m³,
C) 1 to 50 wt % of a binder selected from the group consisting of amino resin, phenol-formaldehyde resin, organic isocyanate having at least two isocyanate groups, or mixtures thereof, optionally with a curing agent, and
D) 0 to 68 wt % of additives,
wherein the vapor barrier comprises from 0.01 to 100 wt % of polyisobutylene, from 0 to 99.99 wt % of further polymers and from 0 to 20 wt % of additives, and also to processes for production thereof and the use thereof.

The present invention relates to multilayered lignocellulosic engineering materials wherein at least one layer is a vapor barrier layer and at least one vapor barrier layer is below the surface of the lignocellulosic engineering material.

U.S. Pat. No. 5,439,749 discloses wood-base materials comprising wood particles or fibers with an integrated vapor barrier, incorporated in the wood-base material in the form of an additional layer. A thermoplastic material, a thermoset material or an aluminum foil is proposed therein for use as vapor barrier layer.

This construction leaves something to be desired, since wood-base materials with such vapor barriers are prone to delaminate. The mechanical strength of these wood-base materials also leaves something to be desired.

The problem addressed by the present invention was therefore that of overcoming the aforementioned disadvantages.

There have accordingly been found novel and improved multilayered lignocellulosic engineering materials wherein at least one layer is a vapor barrier layer and at least one vapor barrier layer is below the surface of the lignocellulosic engineering material, and the lignocellulosic layers comprise
A) 30 to 98 wt % of one or more lignocellulosic substances,
B) 0 to 25 wt % of expanded plastics particles having a bulk density in the range from 10 to 150 kg/m³,
C) 1 to 50 wt % of a binder selected from the group consisting of amino resin, phenol-formaldehyde resin, organic isocyanate having at least two isocyanate groups, or mixtures thereof, optionally with a curing agent, and
D) 0 to 68 wt % of additives,
wherein the vapor barrier comprises from 0.01 to 100 wt % of polyisobutylene, from 0 to 99.99 wt % of further polymers and from 0 to 20 wt % of additives.

There has further been found a novel and improved process for producing multilayered lignocellulosic engineering materials which comprises blending the components
A) 30 to 98 wt % of one or more lignocellulosic substances.
B) 0 to 25 wt % of expanded plastics particles having a bulk density in the range from 10 to 150 kg/m³,
C) 1 to 50 wt % of a binder selected from the group consisting of amino resin, phenol-formaldehyde resin, organic isocyanate having at least two isocyanate groups, or mixtures thereof, and
D) 0 to 68 wt % of additives,
scattering the blend, pre-pressing the scattered blend at elevated pressure and optionally under elevated temperature, layering at least two layers on top of each other while incorporating between these layers a vapor barrier comprising from 0.01 to 100 wt % of polyisobutylene, from 0 to 99.99 wt % of further polymers and from 0 to 20 wt % of additives, and then compression molding the layered assembly under elevated temperature and under elevated pressure.

The sum total of components A), B), C) and D) adds up to 100%.

The term at least 2 (two) layers denotes in general from 2 to 5 layers, i.e., 2, 3, 4 or 5 layers, preferably from 2 to 4 layers, i.e., 2, 3 or 4 layers, more preferably 2 or 3 layers, in particular 2 layers.

The multilayered lignocellulosic engineering materials may further comprise a vapor barrier on a surface. This vapor barrier is generally applied (together) with the other vapor barriers on the inside of the multilayered lignocellulosic engineering materials (or subsequently). However, this surficial vapor barrier may also be provided to the multilayered lignocellulosic engineering materials in a later step.

In one embodiment, the scattered blend after pre-pressing may be separated into at least 2 (two) layers. Processes for separating the layers, for example by means of bandsaws or steam lances, are known to a person skilled in the art (see Barbu, M.; Lerrach, K.; Pölzleitner, F.; Holztechnologie 46 (2005) 1, pages 40 to 44, WO-A-2007/76741 and DE-A-10 2004 006385). The vapor barrier is incorporated in each case between the separated layers and the layers are laid on top of each other and compression molded (hot-pressed).

In one possible embodiment, a blend is scattered, optionally pre-pressed, the vapor barrier is laid onto the surface, a further blend, the composition of which is optionally different from that of the first blend, is scattered onto the vapor barrier, optionally pre-pressed and this operation is repeated until the layered construction with internal vapor barriers is complete and then compression molded (hot-pressed).

Regarding the pre-pressing step, elevated pressure is generally a pressure of 5 to 40 bar, preferably 10 to 30 bar and more preferably 15 to 20 bar and optionally elevated temperature is generally a temperature of 15 to 80° C., preferably 15 to 50° C., more preferably 15 to 28° C. (room temperature) (so-called “cold pressing”).

Regarding the subsequent compression molding (so-called “hot-pressing”), elevated temperature is generally a temperature of 130 to 250° C., preferably 150 to 230° C., and elevated pressure is a pressure of 3 to 70 bar, preferably 4 to 60 bar, more preferably 5 to 50 bar. Pressing time is generally between 1 and 120 seconds, preferably between 2 and 60 seconds and more preferably between 3 and 15 seconds per mm of panel thickness.

In one particular embodiment, two mixtures may also be scattered and pre-pressed under elevated pressure and optionally under elevated temperature and then layered on top of each other, in which case a vapor barrier comprising from 0.01 to 100 wt % of polyisobutylene is incorporated between these layers and thereafter everything is compression molded under elevated temperature and elevated pressure.

These operations are known to a person skilled in the art (see for example Taschenbuch der Spanplattentechnik, DRW-Verlag Weinbrenner, 4th edition 2000, chapters 3.5.1 and 3.5.2).

The number of internal vapor barriers which is incorporable into the lignocellulosic engineering material in the process of the present invention is a matter of discretionary choice; in general it is from one to four, preferably from one to three, more preferably one or two vapor barriers, in particular one vapor barrier.

Generally there are one or more, i.e., from 1 to 4, inner vapor barriers from 5 to 50%, preferably from 7 to 30% and more preferably from 8 to 20% below the surface of the (ready-pressed) multilayered lignocellulosic engineering materials.

The separation between the vapor barriers is generally from 1 to 50 mm, preferably from 2 to 35 mm, more preferably from 3 to 25 mm and most preferably from 5 to 15 mm.

The vapor barrier may be incorporated in the form of pellets or as a self-supporting film or sheet, preferably as a self-supporting film or sheet.

The vapor barrier comprises from 0.01 to 100 wt %, preferably from 0.1 to 50 wt %, preferably from 0.5 to 10 wt % and more preferably from 0.8 to 8 wt % of polyisobutylene, and also from 0 to 99.99 wt % of further polymers and also from 0 to 20 wt %, preferably from 0.1 to 10 wt % and more preferably from 1 to 5 wt % of additives.

A suitable polyisobutylene has a molecular weight (M_{w} in g/mol) in the range from 5000 to 10 000 000, preferably in the range from 10 000 to 5 000 000 and more preferably in the range from 35 000 to 4 500 000.

Further polymers are suitably, for example, polyolefins such as polyethylene or polypropylene, or polyamides such as PA6 or PA6.6 or PA4.6 or PA12 or copolyamides PA6/6.6 or PA6.6.6/12, preferably polyolefins or polyamides, more preferably polyethylenes such as LDPE (Low Density Polyethylene) or LLDPE (Linear Low Density Polyethylene).

Useful additives include for example
pigments e.g. color-grade pigments such as titanium dioxide,
light stabilizers such as benzotriazoles, for example Tinuvin® 326 from BASF SE or hindered amines, for example Tinuvin® 770 from BASF SE or Chimasorb® 2020 from BASF SE
antioxidants such as organophosphites, for example Irgafos® 126 from BASF SE or hindered phenols Irganox® 1010 from BASF SE.

The thickness of the vapor barrier is generally from 0.005 to 5 mm, preferably from 0.01 to 3 mm, more preferably from 0.05 to 1 mm and most preferably from 0.05 to 0.5 mm.

Lignocellulosic engineering materials in this context comprehend optionally veneered flake-base, OSB or fiber-base materials, in particular wood fiber-base materials such as LDF, MDF and HDF materials, preferably flake- or fiber-base materials, more preferably fiber-base materials. Engineering materials include panels, tiles, moldings, semi-fabricates or composites, preferably panels, tiles, moldings or composites, more preferably panels.

Component A

Lignocellulosic substances are substances comprising lignocellulose. The lignocellulose content may be varied within wide limits and is generally from 20 to 100 wt %, preferably from 50 to 100 wt %, more preferably from 85 to 100 wt % and especially equal to 100 wt % of lignocellulose. The term “lignocellulose” is known to a person skilled in the art.

Useful one or more lignocellulosic substances include, for example, straw, woody plants, wood or mixtures thereof. The two or more lignocellulosic substances are generally from 2 to 10, preferably from 2 to 5, more preferably from 2 to 4 and especially 2 or 3 different lignocellulosic substances.

Wood suitably comprises wood fibers or wood particles such as wood laths, wood strips, wood flakes, wood dust or mixtures thereof, preferably wood flakes, wood fibers, wood dust or mixtures thereof, more preferably wood flakes, wood fibers or mixtures thereof. Useful woody plants include, for example, flax, hemp or mixtures thereof.

Starting materials for wood particles or wood fibers are generally forestry thinnings, industrial wood residuals and used lumber and also woody plants and plant parts.

Wood particles or wood fibers may derive from any desired species of wood, preferably spruce, beech, pine, larch, lime, poplar, ash, chestnut and fir wood or mixtures thereof, more preferably spruce and beech wood or mixtures thereof, in particular spruce wood.

Lignocellulosic substances in the invention are generally comminuted and used as particles or fibers.

Suitable particles include sawdust flakes, woodchips, planing flakes, wood particles, optionally comminuted cereal straw, shives, cotton stems or mixtures thereof, preferably sawdust flakes, planing flakes, woodchips, wood particles, shives or mixtures thereof, more preferably sawdust flakes, planing flakes, woodchips, wood particles or mixtures thereof.

The dimensions of comminuted lignocellulosic substances are not critical in that they are in line with the lignocellulosic engineering material to be produced.

Oriented strand board (OSB), for example, is produced using large chips known as strands. Mean particle size of strands used for OSB production is generally in the range from 20 to 300 mm, preferably in the range from 25 to 200 mm and more preferably in the range from 30 to 150 mm.

Flakeboard is generally produced using small chips known as flakes. The particles needed for this can be size classified by sieve analysis. Sieve analysis is described in DIN 4188 or DIN ISO 3310 for example. Mean particle size is generally in the range from 0.01 to 30 mm, preferably in the range from 0.05 to 25 mm and more preferably in the range from 0.1 to 20 mm.

Suitable fibers include wood fibers, cellulose fibers, hemp fibers, cotton fibers, bamboo fibers, miscanthus, bagasse or mixtures thereof, preferably wood fibers, hemp fibers, bamboo fibers, miscanthus, bagasse or mixtures thereof, more preferably wood fibers, bamboo fibers or mixtures thereof. Fiber length is generally in the range from 0.01 to 20 mm, preferably in the range from 0.05 to 15 mm and more preferably in the range from 0.1 to 10 mm.

The particles or fibers are generally—even when varietally pure, i.e., when only one of the aforementioned varieties (e.g., flakes, woodchips or, respectively, wood fibers) is used—in the form of mixtures, the individual parts, particles or fibers of which differ in size and shape.

Processing to form the desired lignocellulosic substances may proceed in accordance with methods known per se (see for example: M. Dunky, P. Niemz, Holzwerkstoffe und Leime, pages 91 to 156, Springer Verlag Heidelberg, 2002).

Lignocellulosic substances are obtainable after they have been dried to the low water contents (in a customary narrow range, known as residual moisture content) customary after customary drying methods known to a person skilled in the art; this water is not included in the weights specified and reported in the present invention.

Mean density of lignocellulosic substances according to the present invention is discretionary, being merely dependent on the lignocellulosic substance used, and is generally in the range from 0.2 to 0.9 g/cm³, preferably in the range from 0.4 to 0.85 g/cm³, more preferably in the range from 0.4 to 0.75 g/cm³ and especially in the range from 0.4 to 0.6 g/cm³.

Lignocellulosic substances are known as high-density lignocellulosic substances when their mean density is in the range from 601 to 1200 kg/m³, preferably in the range from 601 to 850 kg/m³ and more preferably in the range from 601 to 800 kg/m³, and as low-density lignocellulosic substances when their mean density is in the range from 200 to 600 kg/m³, preferably in the range from 300 to 600 kg/m³ and more preferably in the range from 350 to 600 kg/m³. Fiberboard is known as high-density fiberboard (HDF) at a density ≧800 kg/m³, as medium-density fiberboard (MDF) at a density of between 650 and 800 kg/m³ and as lightweight fiberboard (LDF) at a density ≦650 kg/m³.

Component B

Component B) comprises expanded plastics particles coated with at least one binder before, during or after expansion.

Expanded plastics particles, preferably expanded thermoplastics particles, are prepared from expandable plastics particles, preferably expandable thermoplastics particles. Both are based on or consist of polymers, preferably thermoplastic polymers, which can be foamed. These polymers are known to the skilled person.

Examples of highly suitable such polymers are polyketones, polysulfones, polyoxymethylene, PVC (plasticized and unplasticized), polycarbonates, polyisocyanurates, polycarbodiimides, polyacrylimides and polymethacrylimides, polyamides, polyurethanes, amino resins and phenolic resins, styrene homopolymers (also referred to below as “polystyrene” or “styrene polymer”), styrene copolymers, C₂-C₁₀-olefin homopolymers, C₂-C₁₀-olefin copolymers, polyesters, or mixtures thereof, preferably PVC (plasticized and unplasticized), polyurethanes, styrene homopolymer, styrene copolymer, or mixtures thereof, more preferably styrene homopolymer, styrene copolymer, or mixtures thereof, more particularly styrene homopolymer, styrene copolymer, or mixtures thereof.

The above-described, preferred or more preferred expandable styrene polymers or expandable styrene copolymers have a relatively low blowing agent content. Polymers of this kind are also referred to as “low in blowing agent”. One highly suitable process for producing expandable polystyrene or expandable styrene copolymer that is low in blowing agent is described in U.S. Pat. No. 5,112,875, expressly incorporated herein by reference.

As described, it is also possible to use styrene copolymers. These styrene copolymers advantageously include at least 50 wt %, preferably at least 80 wt %, of copolymerized styrene. Examples of comonomers contemplated include α-methylstyrene, ring-halogenated styrenes, acrylonitrile, esters of acrylic or methacrylic acid with alcohols having 1 to 8 C atoms, N-vinylcarbazole, maleic acid (and/or maleic anhydride), (meth)acrylamides and/or vinyl acetate.

The polystyrene and/or styrene copolymer may advantageously comprise in copolymerized form a small amount of a chain branching agent, i.e., of a compound having more than one, preferably two double bonds, such as divinylbenzene, butadiene and/or butanediol diacrylate. The branching agent is used generally in amounts from 0.0005 to 0.5 mol %, based on styrene.

Mixtures of different styrene (co)polymers may also be used.

Highly suitable styrene homopolymers or styrene copolymers are crystal polystyrene (GPPS), high-impact polystyrene (HIPS), anionically polymerized polystyrene or high-impact polystyrene (A-IPS), styrene-α-methylstyrene copolymers, acrylonitrile-butadiene-styrene polymers (ABS), styrene-acrylonitrile (SAN), acrylonitrile-styrene-acrylate (ASA), methyl acrylate-butadiene-styrene (MBS), methyl methacrylate-acrylonitrile-butadiene-styrene (MABS) polymers, or mixtures thereof, or used with polyphenylene ether (PPE).

Preference is given to using styrene polymers, styrene copolymers, or styrene homopolymers having a molecular weight in the range from 70 000 to 400 000 g/mol, more preferably 190 000 to 400 000 g/mol, very preferably 210 000 to 400 000 g/mol.

Polystyrene and/or styrene copolymer of this kind may be produced by any of the polymerization processes known to the skilled person—see, for example, Ullmann's Encyclopedia, Sixth Edition, 2000 Electronic Release, or Kunststoff-Handbuch 1996, volume 4 “Polystyrol”, pages 567 to 598.

Where the expanded plastics particles consist of different types of polymer, i.e., of types of polymer based on different monomers, such as polystyrene and polyethylene, or polystyrene and homo-polypropylene, or polyethylene and homo-polypropylene, these different types of polymer may be present in different weight proportions—which, however, are not critical.

The expanded plastics particles are used in general in the form of beads or pellets with an average diameter of 0.25 to 10 mm, preferably 0.4 to 8.5 mm, more preferably 0.4 to 7 mm, more particularly in the range from 1.2 to 7 mm, and advantageously have a small surface area per unit volume, in the form, for example, of a spherical or elliptical particle.

The expanded plastics particles are advantageously closed-cell. The open-cell content according to DIN-ISO 4590 is generally less than 30%.

The expanded plastics particles have a bulk density of 10 to 150 kg/m³, preferably 30 to 100 kg/m³, more preferably 40 to 80 kg/m³, more particularly 50 to 70 kg/m³. The bulk density is typically ascertained by weighing a defined volume filled with the bulk material.

The expanded plastics particles generally still contain, if any, only a low level of blowing agent. The blowing agent content of the expanded plastics particle is generally in the range from 0 to 5.5 wt %, preferably 0 to 3 wt %, more preferably 0 to 2.5 wt %, very preferably 0 to 2 wt %, based in each case on the expanded polystyrene or expanded styrene copolymer. 0 wt % here means that no blowing agent can be detected using the customary detection methods.

These expanded plastics particles can be put to further use without or with—preferably without—further measures for reduction of blowing agent, and more preferably without further intervening steps, for producing the lignocellulosic substance.

The expandable polystyrene or expandable styrene copolymer, or the expanded polystyrene or expanded styrene copolymer, typically has an antistatic coating.

The expanded plastics particles may be obtained as follows:

Compact, expandable plastics particles, typically solids with in general no cell structure, and comprising an expansion-capable medium (also called “blowing agent”), are expanded (often also called “foamed”) by exposure to heat or a change in pressure. On such exposure, the blowing agent expands, the particles increase in size, and cell structures are formed.

This expansion is carried out in general in customary foaming devices, often referred to as “pre-expanders”. Pre-expanders of this kind may be fixed installations or else movable.

Expansion may be carried out in one or more stages. Generally speaking, with the one-stage process, the expandable plastics particles are expanded directly to the desired final size.

Generally speaking, in the case of the multistage process, the expandable plastics particles are first expanded to an intermediate size, and then expanded to the desired final size in one or more further stages, via a corresponding number of intermediate sizes.

The expansion is preferably carried out in one stage.

For the production of expanded polystyrene as component B) and/or of expanded styrene copolymer as component B), in general, the expandable styrene homopolymers or expandable styrene copolymers are expanded in a known way by heating to temperatures above their softening point, using hot air or, preferably, steam, for example, and/or using pressure change (this expansion often also being termed “foaming”), as described for example in Kunststoff Handbuch 1996, volume 4 “Polystyrol”, Hanser 1996, pages 640 to 673, or in U.S. Pat. No. 5,112,875. The expandable polystyrene or expandable styrene copolymer is generally obtainable in a conventional way by suspension polymerization or by means of extrusion techniques as described above. On expansion, the blowing agent expands, the polymer particles increase in size, and cell structures are formed.

The expandable polystyrene and/or styrene copolymer is prepared in general in a conventional way, by suspension polymerization or by means of extrusion techniques.

In the case of the suspension polymerization, styrene, optionally with addition of further comonomers, is polymerized using radical-forming catalysts in aqueous suspension in the presence of a conventional suspension stabilizer. The blowing agent and optionally further adjuvants may be included in the initial charge in the polymerization, or added to the batch in the course of the polymerization or when polymerization is at an end. The beadlike, expandable styrene polymers impregnated with blowing agent that are obtained, after the end of polymerization, are separated from the aqueous phase, washed, dried, and screened.

In the case of the extrusion process, the blowing agent is mixed into the polymer by an extruder, for example, and the material is conveyed through a die plate and pelletized under pressure to form particles or strands.

The resulting expanded plastics particles or the coated expanded plastics particles can be stored temporarily and transported.

Suitable blowing agents are all blowing agents known to the skilled person, examples being aliphatic C₃ to C₁₀ hydrocarbons such as propane, n-butane, isobutane, n-pentane, isopentane, neopentane, cyclopentane and/or hexane and its isomers, alcohols, ketones, esters, ethers, halogenated hydrocarbons, or mixtures thereof, preferably n-pentane, isopentane, neopentane, cyclopentane, or a mixture thereof, more preferably commercial pentane isomer mixtures composed of n-pentane and isopentane.

The blowing agent content of the expandable plastics particle is generally in the range from 0.01 to 7 wt %, preferably 0.01 to 4 wt %, more preferably 0.1 to 4 wt %, very preferably 0.5 to 3.5 wt %, based in each case on the expandable polystyrene or styrene copolymer containing blowing agent.

Coating of Component B

Suitable coating materials for the expandable or expanded plastics particles include all compounds of components C and also compounds K, which form a tacky layer, or mixtures thereof, preferably all compounds of component C and also compounds K which form a tacky layer, more preferably all compounds of component C. Where the coating material has been selected from components C, it is possible for coating material and component C in the lignocellulosic engineering material to be the same or different, preferably the same.

Suitable compounds K which form a tacky layer are polymers based on monomers such as vinylaromatic monomers, such as α-methylstyrene, p-methylstyrene, ethylstyrene, tert-butyl-styrene, vinylstyrene, vinyltoluene, 1,2-diphenylethylene, 1,1-diphenylethylene, alkenes, such as ethylene or propylene, dienes, such as 1,3-butadiene, 1,3-pentadiene, 1,3-hexadiene, 2,3-dimethylbutadiene, isoprene, or piperylene, α,β-unsaturated carboxylic acids, such as acrylic acid and methacrylic acid, esters thereof, more particularly alkyl esters, such as C₁ to C₁₀ alkyl esters of acrylic acid, more particularly the butyl esters, preferably n-butyl acrylate, and the C₁ to C₁₀ alkyl esters of methacrylic acid, more particularly methyl methacrylate (MMA), or carboxamides, such as acrylamide and methacrylamide, for example. These polymers may optionally comprise 1 to 5 wt % of comonomers, such as (meth)acrylonitrile, (meth)acrylamide, ureido(meth)acrylate, 2-hydroxyethyl (meth)acrylate, 3-hydroxypropyl (meth)acrylate, acrylamidopropanesulfonic acid, methylolacrylamide, or the sodium salt of vinylsulfonic acid. The constituent monomer or monomers of these polymers are preferably one or more of styrene, butadiene, acrylic acid, methacrylic acid, C₁ to C₄ alkyl acrylates, C₁ to C₄ alkyl methacrylates, acrylamide, methacrylamide, and methylolacrylamide. Additionally suitable in particular are acrylate resins, more preferably in the form of the aqueous polymer dispersion, and also homooligomers or homopolymers of α,β-unsaturated carboxylic acids or their anhydrides, and also cooligomers or copolymers of α,β-unsaturated carboxylic acids and/or their anhydrides with ethylenically unsaturated comonomers.

Suitable polymer dispersions are obtainable, for example, by radical emulsion polymerization of ethylenically unsaturated monomers, such as styrene, acrylates, methacrylates, or a mixture thereof, as described in WO-A-00/50480, preferably pure acrylates or styrene-acrylates, synthesized from the monomers styrene, n-butyl acrylate, methyl methacrylate (MMA), methacrylic acid, acrylamide, or methylolacrylamide.

The polymer dispersion or suspension can be prepared in a conventional way, for instance by emulsion, suspension, or dispersion polymerization, preferably in aqueous phase. The polymer may also be prepared by solution or bulk polymerization, optionally comminution, and subsequent, conventional dispersing of the polymer particles in water.

The coating material can be contacted with the expandable plastics particles (i.e., before expansion, “variant I”) or in the expansion of the expandable plastics particles (i.e., during the expansion, “variant II”) or with the expanded plastics particle (i.e., after expansion, “variant III”); variant (III) is used with preference.

The coated plastics particles of the invention are obtainable, for example, by
a) melting plastics particles, preferably nonexpandable plastics particles, adding one or more coating materials and blowing agent in any order, mixing them extremely homogeneously, and foaming the mixture to form foam particles;
b) coating expandable plastics particles with one or more coating materials and foaming them to form foam particles or
c) coating expandable plastics particles with one or more coating materials during or after pre-foaming.

Furthermore, the contacting may take place using the customary methods, as for example by spraying, dipping, wetting or drumming of the expandable or expanded plastics particles with the coating material at a temperature of 0 to 150° C., preferably 10 to 120° C., more preferably 15 to 110° C., under a pressure of 0.01 to 10 bar, preferably 0.1 to 5 bar, more preferably under standard pressure (atmospheric pressure); the coating material is preferably added in the pre-foamer under the conditions specified above.

Component C

Suitable binders are resins such as phenol-formaldehyde resins, amino resins, organic isocyanates having at least 2 isocyanate groups, or mixtures thereof. The resins may be used as they are on their own, as a single resin constituent, or as a combination of two or more resin constituents of the different resins from the group consisting of phenol-formaldehyde resins, amino resins, and organic isocyanates having at least 2 isocyanate groups.

Phenol-Formaldehyde Resins

Phenol-formaldehyde resins (also called PF resins) are known to the skilled person—see, for example, Kunststoff-Handbuch, 2nd edition, Hanser 1988, volume 10 “Duroplast”, pages 12 to 40.

Amino Resins

As amino resins it is possible to use all amino resins that are known to the skilled person, preferably those known for the production of wood-base materials. Resins of this kind and also their preparation are described in for example, Ullmans Enzyklopädie der technischen Chemie, 4th, revised and expanded edition, Verlag Chemie, 1973, pages 403 to 424 “Aminoplaste” and in Ullmann's Encyclopedia of Industrial Chemistry, Vol. A2, VCH Verlagsgesellschaft, 1985, pages 115 to 141 “Amino Resins”, and also in M. Dunky, P. Niemz, Holzwerkstoffe und Leime, Springer 2002, pages 251 to 259 (UF resins) and pages 303 to 313 (MUF and UF with a small amount of melamine), and may be prepared by reaction of compounds containing carbamide groups, preferably urea, melamine, or mixtures thereof, with the aldehydes, preferably formaldehyde, in the desired molar ratios of carbamide group to the aldehyde, preferably in water as solvent.

Setting the desired molar ratio of aldehyde, preferably formaldehyde, to the amino group which is optionally partly substituted by organic radicals, may also be done by addition of monomers bearing —N₂ groups to completed, preferably commercial, relatively formaldehyde-rich amino resins. Monomers bearing NH₂ groups are preferably urea, melamine, or mixtures thereof, more preferably urea.

Amino resins are preferably considered to be polycondensation products of compounds having at least one carbamide group, optionally substituted to some extent by organic radicals (the carbamide group is also referred to as carboxamide group), and of an aldehyde, preferably formaldehyde; with particular preference, urea-formaldehyde resins (UF resins), melamine-formaldehyde resins (MF resins), or melamine-containing urea-formaldehyde resins (MUF resins), more particularly urea-formaldehyde resins, examples being Kaurit® glue products from BASF SE. Amino resins especially preferred in addition are polycondensation products made of compounds having at least one amino group, including amino groups partly substituted by organic radicals, and of aldehyde, in which the molar ratio of aldehyde to the amino group optionally partly substituted by organic radicals is in the range from 0.3:1 to 1:1, preferably 0.3:1 to 0.6:1, more preferably 0.3:1 to 0.45:1, very preferably 0.3:1 to 0.4:1.

The recited amino resins are typically used in liquid form, usually in suspension in a liquid medium, preferably in aqueous suspension, or else are used in solid form.

The solids content of the amino resin suspensions, preferably of the aqueous suspension, is typically 25 to 90 wt %, preferably 50 to 70 wt %.

The solids content of the amino resin in aqueous suspension may be determined according to Günter Zeppenfeld, Dirk Grunwalk, Klebstoffe in der Holz- und Möbelindustrie, 2nd edition, DRW-Verlag, page 268. For determining the solids content of aminoplast glues, 1 g of aminoplast glue is weighed out accurately into a weighing pan, distributed finely on the base, and dried in a drying cabinet at 120° C. for 2 hours. After conditioning to room temperature in a desiccator, the residue is weighed and is calculated as a percentage fraction of the initial mass.

The weight figure for the binder, with regard to the aminoplast component in the binder, is based on the solids content of the corresponding component (determined by evaporating the water at 120° C. over the course of 2 hours, according to Günter Zeppenfeld, Dirk Grunwald, Klebstoffe in der Holz- und Möbelindustrie, 2nd edition, DRW-Verlag, page 268) and, with regard to the isocyanate, more particularly the PMDI, on the isocyanate component per se, in other words, for example, without solvent or emulsifying medium.

Organic Isocyanates

Suitable organic isocyanates are organic isocyanates having at least two isocyanate groups or mixtures thereof, more particularly all organic isocyanates or mixtures thereof that are known to the skilled person, preferably those known for the production of wood-base materials or polyurethanes. Organic isocyanates of these kinds and also their preparation and use are described in Becker/Braun, Kunststoff Handbuch, 3rd revised edition, volume 7 “Polyurethane”, Hanser 1993, pages 17 to 21, pages 76 to 88, and pages 665 to 671, for example.

Preferred organic isocyanates are oligomeric isocyanates having 2 to 10, preferably 2 to 8, monomer units and on average at least one isocyanate group per monomer unit, or mixtures thereof, more preferably the oligomeric organic isocyanate PMDI (“Polymeric Methylene Diphenylene Diisocyanate”), which is obtainable by condensation of formaldehyde with aniline and phosgenation of the isomers and oligomers formed in the condensation (see, for example, Becker/Braun, Kunststoff Handbuch, 3rd revised edition, volume 7 “Polyurethane”, Hanser 1993, page 18, last paragraph, to page 19, second paragraph, and page 76, fifth paragraph), very preferably products of the LUPRANAT® product series from BASF SE, more particularly LUPRANAT® M 20 FB from BASF SE.

Curing Agents in Component C

The binder C) may comprise curing agents or mixtures thereof that are known to the skilled person.

Suitable curing agents include all chemical compounds of any molecular weight that bring about or accelerate the polycondensation of amino resin or phenol-formaldehyde resin, and those which bring about or accelerate the reaction of organic isocyanate having at least two isocyanate groups with water or other compounds or substrates (wood, for example) which comprise —OH or —NH, —NH₂, or ═NH groups.

Suitable curing agents for amino resins or phenol-formaldehyde resins are those which catalyze the further condensation, such as acids or their salts, or aqueous solutions of these salts.

Suitable acids are inorganic acids such as HCl, HBr, HI, H₂SO₃, H₂SO₄, phosphoric acid, polyphosphoric acid, nitric acid, sulfonic acids, as for example p-toluenesulfonic acid, methanesulfonic acid, trifluoromethanesulfonic acid, nonafluorobutanesulfonic acid, carboxylic acids such as C₁to C₈ carboxylic acids as for example formic acid, acetic acid, propionic acid, or mixtures thereof, preferably inorganic acids such as HCl, H₂SO₃, H₂SO₄, phosphoric acid, polyphosphoric acid, nitric acid, sulfonic acids, such as p-toluenesulfonic acid, methanesulfonic acid, carboxylic acids such as C₁ to C₈ carboxylic acids as for example formic acid, acetic acid, more preferably inorganic acids such as H₂SO₄, phosphoric acid, nitric acid, sulfonic acids such as p-toluenesulfonic acid, methanesulfonic acid, and carboxylic acids such as formic acid and acetic acid.

Suitable salts are halides, sulfites, sulfates, hydrogensulfates, carbonates, hydrogencarbonates, nitrites, nitrates, sulfonates, salts of carboxylic acids such as formates, acetates, and propionates, preferably sulfites, carbonates, nitrates, sulfonates, salts of carboxylic acids such as formates, acetates, and propionates, more preferably sulfites, nitrates, sulfonates, salts of carboxylic acids such as formates, acetates, and propionates, of protonated, primary, secondary, and tertiary aliphatic amines, alkanolamines, cyclic aromatic amines such as C₁ to C₈ amines, isopropylamine, 2-ethylhexylamine, di(2-ethylhexyl)amine, diethylamine, dipropylamine, dibutylamine, diisopropylamine, tert-butylamine, triethylamine, tripropylamine, triisopropylamine, tributylamine, monoethanolamine, morpholine, piperidine, pyridine, and also ammonia, preferably protonated primary, secondary, and tertiary aliphatic amines, alkanolamines, cyclic amines, cyclic aromatic amines, and also ammonia, more preferably protonated alkanolamines, cyclic amines, and also ammonia, or mixtures thereof.

Salts that may be mentioned more particularly include the following: ammonium chloride, ammonium bromide, ammonium iodide, ammonium sulfate, ammonium sulfite, ammonium hydrogensulfate, ammonium methanesulfonate, ammonium p-toluenesulfonate, ammonium trifluoromethanesulfonate, ammonium nonafluorobutanesulfonate, ammonium phosphate, ammonium nitrate, ammonium formate, ammonium acetate, morpholinium chloride, morpholinium bromide, morpholinium iodide, morpholinium sulfate, morpholinium sulfite, morpholinium hydrogensulfate, morpholinium methanesulfonate, morpholinium p-toluenesulfonate, morpholinium trifluoromethanesulfonate, morpholinium nonafluorobutanesulfonate, morpholinium phosphate, morpholinium nitrate, morpholinium formate, morpholinium acetate, monoethanolammonium chloride, monoethanolammonium bromide, monoethanolammonium iodide, monoethanolammonium sulfate, monoethanolammonium sulfite, monoethanolammonium hydrogensulfate, monoethanolammonium methanesulfonate, monoethanolammonium p-toluenesulfonate, monoethanolammonium trifluoromethanesulfonate, monoethanolammonium nonafluorobutanesulfonate, monoethanolammonium phosphate, monoethanolammonium nitrate, monoethanolammonium formate, monoethanolammonium acetate, or mixtures thereof.

The salts are used with very particular preference in the form of their aqueous solutions. Aqueous solutions are understood in this context to be dilute, saturated, supersaturated, and also partially precipitated solutions and also saturated solutions with a solids content of salt which is not further soluble.

Phenol-formaldehyde resins may also be cured alkalinically, preferably with carbonates or hydroxides such as potassium carbonate and sodium hydroxide.

Highly suitable curing agents for organic isocyanate having at least two isocyanate groups, as for example PMDI, may be divided into four groups: amines, other bases, metal salts, and organometallic compounds; amines are preferred. Curing agents of these kinds are described in, for example, Michael Szycher, Szycher's Handbook of Polyurethanes, CRC Press, 1999, pages 10-1 to 10-20.

Additionally suitable are compounds which greatly accelerate the reaction of compounds containing reactive hydrogen atoms, more particularly containing hydroxyl groups, with the organic isocyanates.

Usefully used as curing agents are basic polyurethane catalysts, examples being tertiary amines, such as triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)-urea, N-methyl- and N-ethylmorpholine, N-cyclohexylmorpholine, N,N,N′,N′-tetramethylethylene-diamine, N,N,N′,N′-tetramethylbutanediamine, N,N,N′,N′-tetramethylhexane-1,6-diamine, pentamethyldiethylenetriamine, dimethylpiperazine, N-dimethylaminoethylpiperidine, 1,2-dimethylimidazole, 1-azabicyclo[2.2.0]octane, 1,4-diazabicyclo[2.2.2]octane (Dabco), and alkanolamine compounds, such as triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazines, e.g., N,N′,N″-tris(dimethylaminopropyl)-s-hexahydro-triazine, and triethylenediamine.

Suitable organometallic compounds are organometallic salts such as iron(II) chloride, zinc chloride, lead octoate and preferably tin salts such as tin dioctoate, tin diethylhexoate, and dibutyltin dilaurate, more particularly mixtures of tertiary amines and organic tin salts.

Suitability as further bases is possessed by amidines, such as 2,3-dimethyl-3,4,5,6-tetra-hydropyrimidine, tetraalkylammonium hydroxides, such as tetramethylammonium hydroxide, alkali metal hydroxides, such as sodium hydroxide, and alkali metal alkoxides, such as sodium methoxide and potassium isopropoxide, and also by alkali metal salts of long-chain fatty acids having 10 to 20 C atoms and optionally pendant OH groups.

Further examples of curing agents for amino resins are found in M. Dunky, P. Niemz, Holzwerkstoffe und Leime, Springer 2002, pages 265 to 269, such curing agents for phenol-formaldehyde resins are found in M. Dunky, P. Niemz, Holzwerkstoffe und Leime, Springer 2002, pages 341 to 352, and such curing agents for organic isocyanates having at least 2 isocyanate groups are found in M. Dunky, P. Niemz, Holzwerkstoffe und Leime, Springer 2002, pages 385 to 391.

Component D)

The lignocellulosic engineering materials of the present invention may comprise, as component D, additives known to a person skilled in the art and commercially available, in amounts of 0 to 68 wt %, preferably 0 to 10 wt %, more preferably 0.5 to 8 wt %, especially 1 to 3 wt %.

Examples of suitable additives include hydrophobicizing agents such as paraffin emulsions, antifungal agents, formaldehyde scavengers, such as urea or polyamines, and flame retardants, extenders, and fillers. Further examples of additives are found in M. Dunky, P. Niemz, Holzwerkstoffe und Leime, Springer 2002, pages 436 to 444.

Amounts of Components in Lignocellulosic Engineering Material

The total amount of coating material on the expanded plastics particles B) {based on the amount of the uncoated plastics particles} is in the range from 0.01 to 20 wt %, preferably 0.05 to 15 wt %, more preferably 0.1 to 10 wt %.

Even after pressing has taken place to form the lignocellulosic engineering material, preferably wood-base material, preferably multilayered lignocellulosic engineering material, more preferably multilayered wood-base material, the coated, expanded plastics particles B) are generally present in a virtually unmelted state. This means that in general the plastics particles B) have not penetrated the lignocellulose particles or impregnated them, but they are instead distributed between the lignocellulose particles. The plastics particles B) can be separated from the lignocellulose typically by physical methods, after the comminution of the lignocellulosic engineering material, for example.

The total amount of the coated, expanded plastics particles B), based on the lignocellulosic, preferably wood-containing substance, is in the range from 1 to 25 wt %, preferably 3 to 20 wt %, more preferably 5 to 15 wt %.

The total amount of the binder C), based on the lignocellulosic substances, is generally in the range from 1 to 50 wt %, preferably 2 to 15 wt %, more preferably 3 to 10 wt %, with the amount
a) of the phenol-formaldehyde resin, based on the lignocellulosic substances, being generally in the range from 0 to 50 wt %, preferably 4 to 20 wt %, more preferably 5 to 15 wt %,
b) of the amino resin (calculated as solid, based on the lignocellulosic substances) being generally in the range from 0 to 45 wt %, preferably 4 to 20 wt %, more preferably 5 to 15 wt %, and
c) of the organic isocyanate, based on the lignocellulosic substances, being generally in the range from 0 to 7 wt %, preferably 0.1 to 5 wt %, more preferably 0.5 to 4 wt %.

Multilayered Process

The present invention further provides a process for producing a multilayered lignocellulosic engineering material comprising at least three layers, wherein either only the middle layer or at least some of the middle layers comprise a lignocellulosic substance as defined above, or wherein at least one further layer, as well as the middle layer or at least some of the middle layers, comprises a lignocellulosic substance as defined above, wherein the components for the individual layers are layered atop one another and compressed at elevated temperature and elevated pressure.

The average density of the multilayered, preferably three-layered, lignocellulosic engineering material, preferably wood-base material, of the invention is generally not critical.

Comparatively high-density multilayered, preferably three-layered, lignocellulosic engineering materials, preferably wood-base materials, of the invention typically have an average density in the range from at least 600 to 900 kg/m³, preferably in the range from 600 to 850 kg/m³ and more preferably in the range from 600 to 800 kg/m³.

Low-density multilayered, preferably three-layered, lignocellulosic engineering materials, preferably wood-base materials, of the invention typically have an average density in the range from 200 to 600 kg/m³, preferably in the range from 300 to 600 kg/m³ and more preferably in the range from 350 to 500 kg/m³.

Preferred parameter ranges and also preferred embodiments for the average density of the lignocellulosic, preferably woody, substance and for the components and also their production processes A), B), C) and D) and also the combination of the features correspond to those described above.

Middle layers for the purposes of the invention are any layers which are not the outer layers.

In one preferred embodiment, the outer layers do not contain any expanded plastics particles B).

The multilayered lignocellulosic engineering material, preferably multilayered wood-base material, of the present invention preferably comprises three lignocellulosic layers, preferably wood pulp layers, while the outer layers are generally thinner in total than the inner layer or layers.

The binder used for the outer layers is typically an amino resin, as for example urea-formaldehyde resin (UF), melamine-formaldehyde resin (MF), melamine-urea-formaldehyde resin (MUF), or the binder C) of the invention. The binder used for the outer layers is preferably an amino resin, more preferably a urea-formaldehyde resin, very preferably an amino resin in which the molar formaldehyde-to-—NH₂-groups ratio is in the range from 0.3:1 to 3:1.

The thickness of the multilayered lignocellulosic engineering material, preferably multilayered wood-base material, of the invention varies with the field of use and is generally in the range from 0.5 to 100 mm, preferably in the range from 10 to 40 mm, especially in the range from 12 to 40 mm.

The methods for producing multilayered wood-base materials are known in principle and described for example in M. Dunky, P. Niemz, Holzwerkstoffe und Leime, Springer 2002, pages 91 to 150.

One example of a method for producing a multilayered wood-base material of the invention is described hereinafter.

Component B is first foamed up from expandable plastics particles and coated with coating material.

The blowing agent-containing expandable plastics pellet material was prefoamed into bead foam in a commercially available EPS pressure prefoamer (from Erlenbach) having a capacity of 180 liters (about 50 cm in diameter and about 100 cm in height) from a 2000 g charge of Kaurit-Light-200 pellet. During prefoaming, the coating material was sprayed into the pressure prefoamer as a 27 wt % solution (dissolved in water).

Coated component B) thus obtained can then be further used directly or after storage.

After the wood has been flaked, the flakes are dried. Then any coarse and fine fractions are removed. The remaining flakes are sorted by screening or classifying in a stream of air. The coarser material is used for the middle layer, the finer material for the outer layers.

The outer-layer flakes are resinated, or mixed, separately from the middle-layer flakes, with component C), with curing agents—these curing agents are preferably admixed shortly before the use of the component C—and optionally with component D. This mixture is referred to below as outer-layer material.

The middle-layer flakes are resinated, or mixed, separately from the outer-layer flakes with coated component B), component C, with curing agents—these curing agents are preferably admixed shortly before the use of the component C—and optionally with component D. This mixture is referred to below as middle-layer material.

The flakes are subsequently scattered.

First the outer-layer material is scattered onto the shaping belt, then the middle-layer material—comprising the coated components B), C) and optionally D)—and finally outer-layer material one more time. The outer-layer material is divided such that both outer layers comprise approximately equal amounts of material. The three-layer flake cake produced in this way is subjected to cold (generally room-temperature) precompaction and then to hot pressing.

Pressing may take place by any methods known to the skilled person. The cake of wood particles is typically pressed to the desired thickness at a pressing temperature of 150 to 230° C.

The pressing time is normally 3 to 15 seconds per mm of panel thickness. A three-layer flakeboard panel is obtained.

Mechanical strength may be determined by measurement of the transverse tensile strength in accordance with EN 319.

The effect of coating component B) is to reduce/suppress/inhibit the migration of individual plastics particles to the surface and also to reduce the overall amount of binder in the lignocellulosic engineering material of the present invention.

Lignocellulosic engineering materials, more particularly multilayered wood-base materials, are an inexpensive alternative to solid wood, representing a sparing use of resources; they have great significance, and are used in the manufacture of articles of any kind and in the building construction sector, more particularly in the manufacture of furniture and furniture components (in furniture construction), of packaging materials, of laminate flooring, and as building construction materials, in house building or in interior fitment, or in motor vehicles.

The expandable or expanded plastics particles are suitable for producing shaped lignocellulosic articles (use).

### EXAMPLES

Production of Glue Liquor

A 67 wt % aqueous solution of Kaurit® 347 liquid glue from BASF SE (Technical Infosheet M 6167 d, February 2008, BASF SE) in a molar ratio of formaldehyde to urea of 1.09:1 was admixed with 0.4 wt % of a 52 wt % aqueous ammonium nitrate solution and 14 wt % of water.

Panel Production

950 g of the glue solution obtained above are mixed with 5.4 kg of wood flakes, resulting in a resination of 10% atro (atro=solid resin per dry wood).

The resinated wood flakes were first scattered to form a flake cake 500×500 mm in size and 150 mm in height. Then, one of the self-supporting plastics films or sheets listed in table 1 was laid on top of the flake cake and further flakes were scattered onto said film or sheet until the overall height of the flake cake was 200 mm.

The resinated wood flakes with the internal plastics film or sheet are pressed in a hot press at 210° C. for 180 sec to form 19 mm thick wood flakeboard panel by reducing the molding pressure after 60 seconds from initially 40 bar to 20 bar and after a further 60 seconds to 10 bar. After cooling to room temperature and storing for at least 24 hours, the wood flakeboard panels thus obtained are examined.

Analysis and Experimental Results

EN 312 transverse tensile strength was determined on the laboratory panels according to inventive examples (Nos. 1 and 2) and to comparative examples (A, B, C, D, E, F and G).

| | | Thickness | |
|---|---|---|---|
| | | of vapor | |
| | | barrier | EN 312 transverse tensile |
| Example | Vapor barrier used | [mm] | [N/mm²] |
| 1 | film F1 (see below) | 0.03 | 0.67 |
| A | aluminum foil | 0.3 | aluminum foil disintegrates |
| | | | during pressing, so the |
| | | | vapor barrier effect is lost |
| | | | and there is no vapor |
| | | | barrier in the engineering |
| | | | material |
| B | Ultramid ® B33L | 0.05 | no determination possible, |
| | nylon 6 | | delamination |
| C | Ultramid ® C33L | 0.05 | 0.23 |
| | nylon 6, 66 | | |
| | copolymer | | |
| 2 | Oppanol ® B200 | 2 | 0.46 |
| D | OTTOWOLFF | 2 | no determination possible, |
| | OWOCOR ® | | delamination |
| | modelmaking | | |
| | polystyrene | | |
| E | commercial grade | 1.5 | no determination possible, |
| | blank flat aluminum | | delamination |
| | sheet | | |
| F | Gutta Hobbycolor | 3 | no determination possible, |
| | PVC | | delamination |
| G | Guttacryl | 3 | no determination possible, |
| | acrylic glass | | delamination |

Film F1: consisted of altogether seven layers having the following composition (particulars below all in % by weight (wt %), total polyisobutylene fraction about 0.5 to 1 wt %):
Dowlex® 2045S (80 wt %), Lupolen® 2420F (18.5 wt %), ARX® 901 (1.5 wt %)
Dowlex® 2045S (70 wt %), Lupolen® 2420F (18.5 wt %), Euthylen® Weiss (10 wt %), ARX® 901 (1.5 wt %)
Dowlex® 2045S (80 wt %), Lupolen® 2420F (20 wt %)
Dowlex® 2045S (80 wt %), Lupolen® 2420F (20 wt %)
Dowlex® 2045S (80 wt %), Lupolen® 2420F (20 wt %)
Dowlex® 2045S (70 wt %), Lupolen® 2420F (18.5 wt %), Euthylen® Weiss (10 wt %), ARX® 901 (1.5 wt %)
Dowlex® 2045S (70 wt %), Lupolen® 2420F (18.5 wt %), Polybatch TAC® 100 (10 wt %), ARX® 901 (1.5 wt %)
   Dowlex® 2045S is an LLDPE (Linear Low Density Polyethylene) from Dow Chemicals
   Lupolen® 2420F is an LDPE (Low Density Polyethylene) from LyondellBasell
   Euthylen® Weiss is a titanium dioxide from BASF SE
   Polybatch TAC®100 is a masterbatch from A. Schulman and consists of 60 wt % of polyisobutylene and 40 wt % of LDPE
   ARX® 901 is a UV stabilizer for plastics from Argus

The film was produced on a 7 layer blown film system from Collin. Extruders B-F had an internal diameter of 30 mm and an internal length of 750 mm. Extruder A had an internal diameter of 45 mm and an internal length of 1125 mm. The spiral casing blown film die had a diameter of 180 mm. The cooling section from the die to the collapsing boards was 8.5 m in length.

To produce the film described, the extruders were operated at a melt temperature of 215-232° C. Takeoff speed was 15.5 m/min. Throughput per hour was about 5 kg for extruder A, about 3 kg for extruder C and about 3.5 kg for all other extruders.

1.-14. (canceled)

15. A process for producing a multilayered lignocellulosic engineering material, which process comprises blending
A) 30 to 98 wt % of one or more lignocellulosic substances,
B) 0 to 25 wt % of expanded plastics particles having a bulk density in the range from 10 to 150 kg/m³,
C) 1 to 50 wt % of a binder selected from the group consisting of amino resin, phenol-formaldehyde resin, organic isocyanate having at least two isocyanate groups, or mixtures thereof, and
D) 0 to 68 wt % of additives,
scattering the blend, pre-pressing the scattered blend at elevated pressure and optionally under elevated temperature, layering at least two layers on top of each other while incorporating between these layers a vapor barrier comprising from 0.01 to 100 wt % of polyisobutylene, from 0 to 99.99 wt % of further polymers and from 0 to 20 wt % of additives, and then compression molding the layered assembly under elevated temperature and under elevated pressure.

16. The process according to claim 15, wherein the scattered blend after pre-pressing is separated into at least 2 (two) layers, the vapor barrier is incorporated between the separated layers, and the layers are laid on top of each other and hot-pressed.

17. The process according to claim 15, wherein the vapor barrier is a self-supporting polymeric film or sheet.

18. The process according to claim 15, wherein the polyisobutylene in the vapor barrier has a molecular weight in the range from 5000 to 10 000 000 g/mol.

19. The process according to claim 15, wherein the vapor barrier further comprises from 0.1 to 10 wt % of additives.

20. The process according to claim 15, wherein one or more inner vapor barriers are from 5 to 50% below the surface of the final compression-molded multilayered lignocellulosic engineering material.

21. The process according to claim 15, wherein the multilayered lignocellulosic engineering material further comprises a vapor barrier on a surface.

22. The process according to claim 15, wherein a blend is scattered, optionally pre-pressed, the vapor barrier is laid onto the surface, a further blend, the composition of which is optionally different from that of the first blend, is scattered onto the vapor barrier, optionally pre-pressed and optionally this operation is repeated until the layered construction with internal vapor barriers is complete and then hot-pressed.

23. A multilayered lignocellulosic engineering material obtainable by the process according to claim 15.

24. The method of using the multilayered lignocellulosic engineering material according to claim 23 in the manufacture of articles of any kind and in the building construction sector.

25. The method of using a lignocellulosic lignocellulosic engineering material according to claim 23 in the manufacture of furniture and furniture components, of packaging materials, of laminate flooring, as building construction materials.

26. An article which comprises the multilayered lignocellulosic engineering material according to claim 23.

27. The article as claimed in claim 26, wherein the article is a packaging material, laminate flooring, building construction material or a furniture component.
